(19) United States
(12) Patent Application Publication
(10) Pub. No.: US 2018/0165660 A1
(43) Pub. Date: Jun. 14, 2018

(54) MANAGING A DEMAND ON AN ELECTRICAL GRID USING A PUBLICLY DISTRIBUTED TRANSACTIONS LEDGER

(71) Applicant: Wal-Mart Stores, Inc., Bentonville, AR (US)

(72) Inventors: Donald R. High, Noel, MO (US); Bruce Walter Wilkinson, Rogers, AR (US); Todd Mattingly, Bentonville, AR (US); Brian Gerard McHale, Oldham (GB); John J. O'Brien, V, Farmington, AR (US); Robert Cantrell, Herndon, VA (US); Joseph Jurich, JR., Molino, FL (US)

(21) Appl. No.: 15/840,724

(22) Filed: Dec. 13, 2017

Related U.S. Application Data
(60) Provisional application No. 62/433,968, filed on Dec. 14, 2016.

(51) Int. Cl. G06Q 20/06; G06Q 50/06; H04L 9/06; G06Q 20/14

(52) U.S. Cl. CPC G06Q 20/065; G06Q 50/06; H04L 2209/56; G06Q 20/145; H04L 9/0637

(57) ABSTRACT

A method and system for managing a demand on an electrical grid is provided, including: receiving a capped total amount of cryptocurrency available to purchase units of energy from an energy provider, the capped amount of cryptocurrency being recorded in a publicly distributed transaction ledger, allocating a portion of the cryptocurrency of the capped total amount of cryptocurrency to each energy consumption device, wherein the portion of the cryptocurrency allocated to each energy consumption device is recorded in the ledger, receiving, a request from an energy consumption device of the plurality of energy consumption devices that the energy metering device purchase an energy unit, using the portion of cryptocurrency allocated to the first energy consumption device, accessing the publically distributed transaction ledger in response to receiving the request from the first energy consumption to verify that the first energy consumption device has a remaining amount of cryptocurrency.

### RELATED APPLICATIONS

This application claims the benefit of U.S. Provisional Patent No. 62/433,968 filed Dec. 14, 2016, entitled “Managing a Demand on an Electrical Grid Using a Publically Distributed Transactions Ledger,” the contents of which are incorporated by reference herein in their entirety.

### FIELD OF TECHNOLOGY

The following relates to an electrical grid management system, and more specifically to a method and system for managing and regulating a demand on an electrical grid using a publicly distributed transactions ledger.

### BACKGROUND

Currently, energy providers deliver energy to locations that inefficiently use the energy, which leads to increased energy costs for consumers. The increased costs result from various appliances and devices that consume energy at higher levels than the appliance or device may actually need to function or perform certain tasks. Smart appliances and devices are now available to consumers that can operate more energy efficiently, but still consume more energy than needed or economically practical.

Thus, there is a need for a method and system for managing an electrical grid by regulating a demand on the electrical grid.

### SUMMARY

A first aspect relates to a method for managing a demand on an electrical grid, comprising: receiving, by an energy metering device, a capped total amount of cryptocurrency available to purchase units of energy from an energy provider over a period of time for a single network connected to the electrical grid, the capped total amount of cryptocurrency being recorded in a publicly distributed transaction ledger, detecting, by the energy metering device, a plurality of energy consumption devices associated with the single network, allocating, by the energy metering device, a portion of the cryptocurrency of the capped total amount of cryptocurrency to each energy consumption device, wherein the portion of the cryptocurrency allocated to each energy consumption device is recorded in the publicly distributed transaction ledger, receiving, by the energy metering device, a request from an energy consumption device of the plurality of energy consumption devices that the energy metering device purchase an energy unit from the energy provider, using the portion of cryptocurrency allocated to the first energy consumption device, the request based on a current energy need of the first energy consumption device, accessing, by the energy metering device, the publically distributed transaction ledger in response to receiving the request from the first energy consumption to verify that the first energy consumption device has a remaining amount of cryptocurrency, and purchasing, by the energy metering device, a unit of energy from the energy provider to be delivered to the first energy device after verifying that the first energy consumption device has sufficient cryptocurrency to spend on energy.

A second aspect relates to a system for managing a demand on an electrical grid, comprising: an energy provider, the energy provider configured to deliver a limited amount of energy to a single network, the energy provider determining a capped total amount of cryptocurrency available for purchase by the single network, and an energy metering device, the first energy metering device being associated with the single network, and communicatively coupled to the energy provider over a communication network, wherein the first energy metering device manages the demand on the electrical grid by: receiving, by the energy metering device, the capped total amount of cryptocurrency available to purchase units of energy from the energy provider over a period of time for the single network connected to the electrical grid, the capped total amount of cryptocurrency being recorded in a publicly distributed transaction ledger, detecting, by the energy metering device, a plurality of energy consumption devices associated with the single network, allocating, by the energy metering device, a portion of the cryptocurrency of the capped total amount of cryptocurrency to each energy consumption device, wherein the portion of the cryptocurrency allocated to each energy consumption device is recorded in the publicly distributed transaction ledger, receiving, by the energy metering device, a request from an energy consumption device of the plurality of energy consumption devices that the energy metering device purchase an energy unit from the energy provider, using the portion of cryptocurrency allocated to the first energy consumption device, the request based on a current energy need of the first energy consumption device, accessing, by the energy metering device, the publically distributed transaction ledger in response to receiving the request from the first energy consumption to verify that the first energy consumption device has a remaining amount of cryptocurrency, and purchasing, by the energy metering device, a unit of energy from the energy provider to be delivered to the first energy device after verifying that the first energy consumption device has sufficient cryptocurrency to spend on energy

A third aspect relates to a computer system, comprising: a processor, a memory device coupled to the processor, and a computer readable storage device coupled to the processor, wherein the storage device contains program code executable by the processor via the memory device to implement a method for managing a demand of an electrical grid, the method comprising: receiving, by an energy metering device, a capped total amount of cryptocurrency available to purchase units of energy from an energy provider over a period of time for a single network connected to the electrical grid, the capped total amount of cryptocurrency being recorded in a publicly distributed transaction ledger, detecting, by the energy metering device, a plurality of energy consumption devices associated with the single network, allocating, by the energy metering device, a portion of the cryptocurrency of the capped total amount of cryptocurrency to each energy consumption device, wherein the portion of the cryptocurrency allocated to each energy consumption device is recorded in the publicly distributed transaction ledger, receiving, by the energy metering device, a request from an energy consumption device of the plurality of energy consumption devices that the energy metering device purchase an energy unit from the energy provider, using the portion of cryptocurrency allocated to the first energy consumption device, the request based on a current energy need of the first energy consumption device, accessing, by the energy metering device, the publically distributed transaction ledger in response to receiving the request from the first energy consumption to verify that the first energy consumption device has a remaining amount of cryptocurrency, and purchasing, by the energy metering device, a unit of energy from the energy provider to be delivered to the first energy device after verifying that the first energy consumption device has sufficient cryptocurrency to spend on energy.

The foregoing and other features of construction and operation will be more readily understood and fully appreciated from the following detailed disclosure, taken in conjunction with accompanying drawings.

### BRIEF DESCRIPTION OF THE DRAWINGS

Some of the embodiments will be described in detail, with reference to the following figures, wherein like designations denote like members, wherein:

FIG. 1 depicts a block diagram of an electrical grid, in accordance with embodiments of the present invention;

FIG. 2 depicts a block diagram of a network as shown in FIG. 1, connected to the energy provider, in accordance with embodiments of the present invention;

FIG. 3 depicts a block diagram of an electrical grid management system, in accordance with embodiments of the present invention;

FIG. 4 depicts an embodiment of a publicly distributable transactions ledger, in accordance with embodiments of the present invention;

FIG. 5 depicts a blockchain and two exemplary blocks of the blockchain, in accordance with embodiments of the present invention.

FIG. 6 depicts a flow chart of a method for managing a demand of an electrical grid, in accordance with embodiments of the present invention; and

FIG. 7 illustrates a block diagram of a computer system for the electrical grid management system of FIG. 3, capable of implementing methods for managing a demand on an electrical grid of FIG. 6, in accordance with embodiments of the present invention.

### DETAILED DESCRIPTION

Although certain embodiments are shown and described in detail, it should be understood that various changes and modifications may be made without departing from the scope of the appended claims. The scope of the present disclosure will in no way be limited to the number of constituting components, the materials thereof, the shapes thereof, the relative arrangement thereof, etc., and are disclosed simply as an example of embodiments of the present disclosure. A more complete understanding of the present embodiments and advantages thereof may be acquired by referring to the following description taken in conjunction with the accompanying drawings, in which like reference numbers indicate like features.

As a preface to the detailed description, it should be noted that, as used in this specification and the appended claims, the singular forms “a”, “an” and “the” include plural referents, unless the context clearly dictates otherwise.

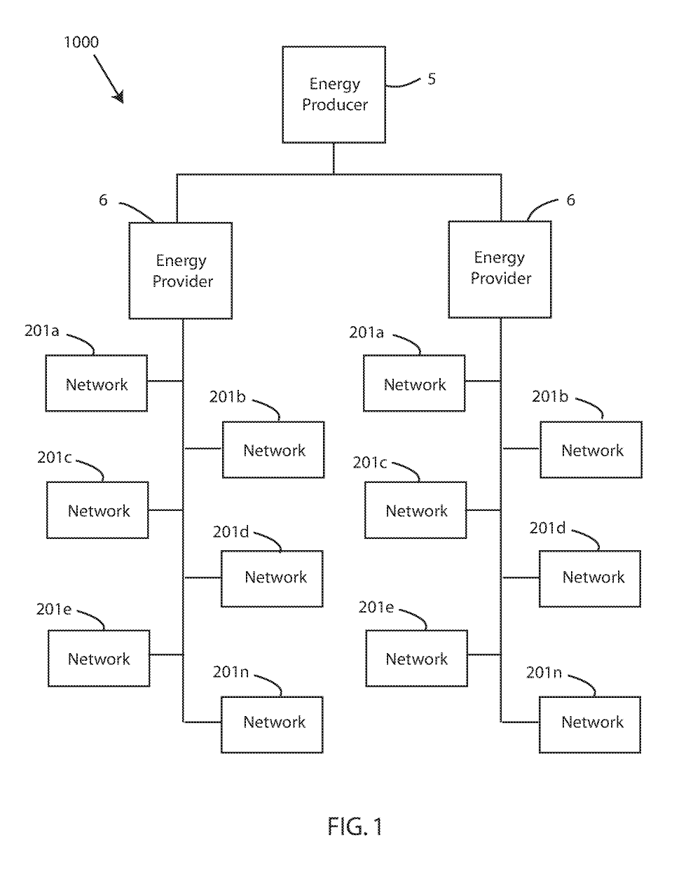

Referring to the drawings, FIG. 1 depicts a block diagram of an electrical grid 1000, in accordance with embodiments of the present invention. Embodiments of the electrical grid 1000 may include an energy producer 5, an energy provider 6, and a plurality of networks 201a, 201b, 201c, 201d, 201d, 201e . . . 201n (individually networks referred to as network 201). Embodiments of the energy producer 5 may be an entity that manufactures, generates, and/or produces energy for the electrical grid 1000 to be consumed. Exemplary embodiments of an energy producer 5 may include an industrial power plant, a coal plant, a nuclear plant, a wind farm, a solar array, a hydro-electric power plant, and the like. In some embodiments, the electrical grid 100 may include more than one energy producer 5. Moreover, embodiments of the electrical grid 1000 may include one or more energy providers 6. Embodiments of the energy provider 6 may be an entity that distributes or otherwise delivers energy for sale to one or more networks or markets. Exemplary embodiments of an energy provider 6 may be a utility company or an electric utility that obtains energy from one or more energy producer 6, and facilitates delivery to locations where the energy will be consumed, such as network 201. In some embodiments, the energy producer 5 may be the same entity as the energy provider 6. The energy provider 6 may communicate with network 201 to sell units of energy to the network 201. However, the energy provider 6 may set a limit of total energy supplied to the network 201 over a period of time to manage and/or regulate a demand on the electrical grid 1000, as will be described in greater detail infra.

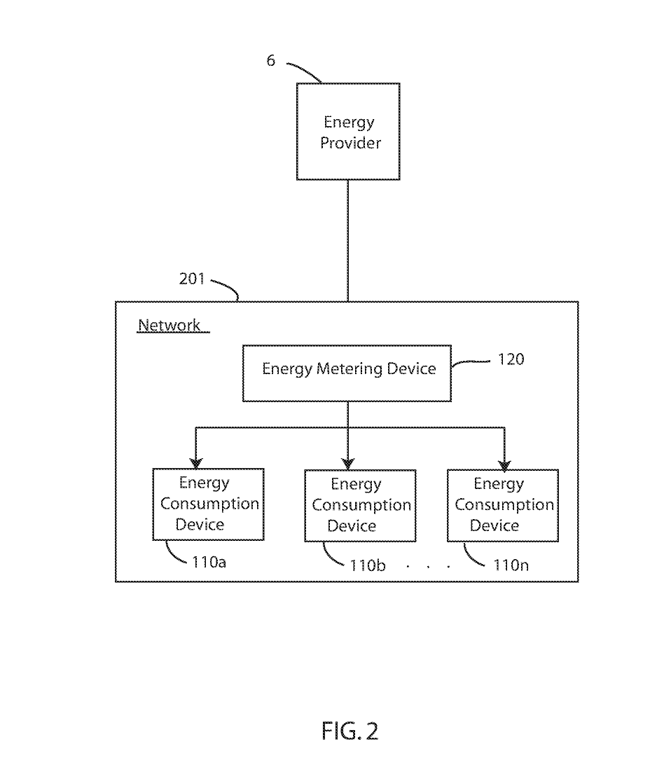

FIG. 2 depicts a block diagram of a network 201 as shown in FIG. 1, connected to the energy provider 6, in accordance with embodiments of the present invention. Embodiments of network 201 may be an end user of energy, an energy consumer, an energy purchaser, and the like, that interfaces with the energy provider 6 to buy or sell units of energy from the electrical grid 1000. Each network 201 may include at least one energy metering device 120. Embodiments of the energy metering device 120 may be a smart meter, an energy meter, a regulator, an energy facilitator, an energy metering apparatus, an energy transaction manager, an energy purchase moderator, and the like. The energy metering device 120 may be a computing system that communicates with the energy provider 6 to purchase or sell units of energy for the network 201. Embodiments of the energy metering device 120 may be connected to a plurality of energy consuming devices 110a, 110b . . . 110n, which may be present in the network 201. For example, a single network 201 may include a plurality of energy consuming devices 110a, 110b . . . 110n, wherein each of the energy consuming devices 110a, 110b . . . 110n consume energy from the electrical grid 1000. The energy metering device 120 may facilitate energy delivery to the energy consumption devices 110a, 110b . . . 110n. Embodiments of the energy consumption devices 110a, 110b . . . 110n may be an appliance, a light source, an entertainment console, a computing device, a heating system, a cooling system, a water heating system, and the like, that is capable of connecting to the internet or other communication network. Further, embodiments of network 201 may be a network, a domain, a location, a consumer, a residence, a building, a workspace, an office, a retail store, a distribution center, a neighborhood, and the like. In an exemplary embodiment, the network 201 may be a residence, dwelling, or retail store that uses energy from the electrical grid 1000. A plurality of networks 201 may be combined to form a larger network, such as a neighborhood or city, or a chain of retail stores, a chain of distribution centers, and/or a combination thereof.

By managing a demand or total usage of energy of each network 201 in a larger network, an aggregate effect of reducing significant loads on the electrical grid 1000 may result. Embodiments of the energy metering device 120 associated with each network 201 may be used to regulate, monitor, and enforce a capped amount of energy allotted to the network 201, using a publicly distributed transaction ledger, such as the blockchain. The immutable characteristics of the blockchain provide a decentralized, trusted database for accounting the transactions to buy/sell units of energy between the energy metering device 120, the energy consumption devices 110a, 110b . . . 110b, and the energy provider 6, without the need for a power company, such as energy provider 6, to maintain such an accounting. Thus, a cap may be set (e.g. by the energy provider 6, a municipality, a franchise headquarters, company executives, business management, a state or federal government agency, etc.) for each network 201, and due to the nature of blockchain, no device on the network 201 may be able to purchase more energy than allotted for a given period of time.

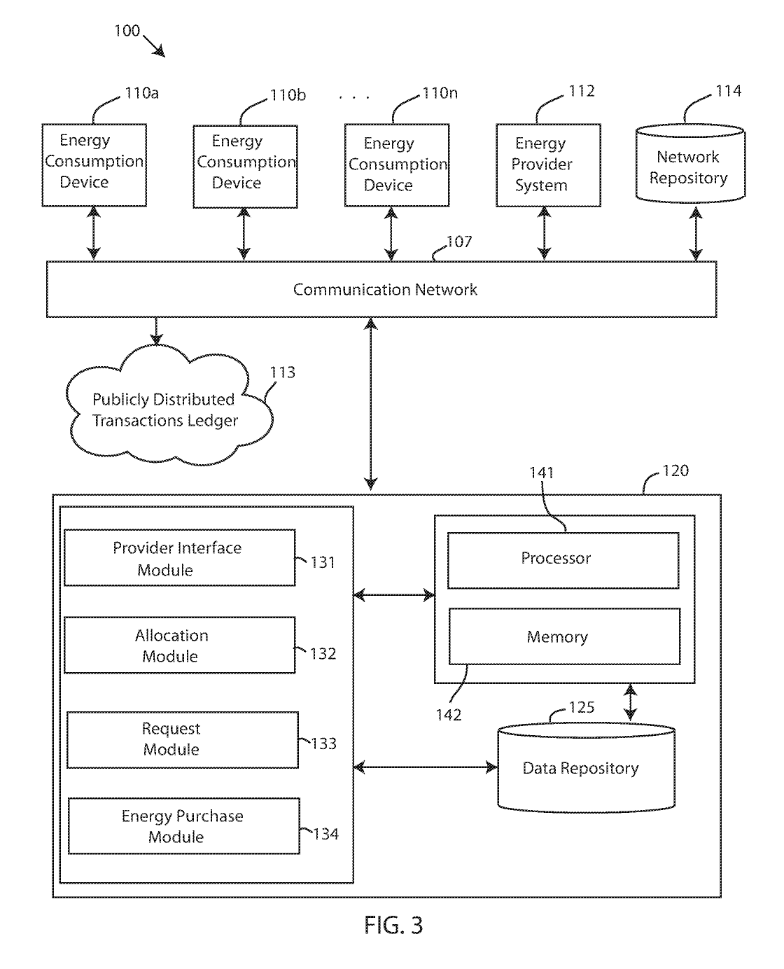

FIG. 3 depicts a block diagram of an electrical grid management system 100, in accordance with embodiments of the present invention. Embodiments of an electrical grid management system 100 may be described as a system for managing and/or regulating a demand on the electrical grid 1000. Embodiment of electrical grid management system 100 may comprise a plurality of energy consumption devices 110a, 110b . . . 110n communicatively coupled to the energy metering device 120 over a communication network 107. The number of plurality of energy consumption devices 110a, 110b . . . 110n connecting to the energy metering device 120 over communication network 107 may vary from embodiment to embodiment. As shown in FIG. 3, the plurality of energy consumption devices 110a, 110b . . . 110n may transmit requests to the energy metering device 120 to buy or sell energy units. A communication network 107 may refer to a group of two or more computer systems linked together. Communication network 107 may be any type of computer network known by individuals skilled in the art. Examples of computer networks 107 may include a LAN, WAN, campus area networks (CAN), home area networks (HAN), metropolitan area networks (MAN), an enterprise network, cloud computing network (either physical or virtual) e.g. the Internet, a cellular communication network such as GSM or CDMA network or a mobile communications data network. The architecture of the communication network 107 may be a peer-to-peer network in some embodiments, wherein in other embodiments, the network 107 may be organized as a client/server architecture.

In some embodiments, the network 107 may further comprise, in addition to the energy metering device 120, plurality of energy consumption devices 110a, 110b . . . 110n, and energy provider system 112, a connection to one or more network accessible knowledge bases containing information of one or more users associated with network 201, network repositories 114 or other systems connected to the network 107 that may be considered nodes of the network 107. In some embodiments, where the energy metering device 120 or network repositories 114 allocate resources to be used by the other nodes of the network 107, the energy metering device 120 and network repository 114 may be referred to as servers.

The network repository 114 may be a data collection area on the network 107 which may back up and save all the data transmitted back and forth between the nodes of the network 107. For example, the network repository 114 may be a data center saving and cataloging user or network 201 data regarding energy usage to generate both historical and predictive reports regarding a particular network 201. In some embodiments, a data collection center housing the network repository 114 may include an analytic module capable of analyzing each piece of data being stored by the network repository 114. Further, the energy metering device 120 may be integrated with or as a part of the data collection center housing the network repository 114. In some alternative embodiments, the network repository 114 may be a local repository (not shown) that is connected to the energy metering device 120.

Referring still to FIG. 3, embodiments of the energy metering device 120 may receive requests and other information from the plurality of energy consumption devices 110a, 110b . . . 110n which may be positioned within or connected to an environment of the network 201. The plurality of energy consumption devices 110a, 110b . . . 110n may be smart devices that may be able to determine how much energy is needed to operate at various levels of activity. For example, the plurality of energy consumption devices 110a, 110b . . . 110n may each have a computing system with a processor and other hardware components and specialized circuitry running software that may be able to efficiently regulate and/or manage energy use. As opposed to just consuming energy, such as electricity, to operate/function at 100%, the energy consumption devices 110a, 110b . . . 110n may calculate how much energy is needed to perform a given task, and purchase energy accordingly. As an example, a smart refrigerator may determine the amount of energy required to maintain a particular refrigerated environment, and only purchase energy required to maintain the particular refrigerated environment. A further example may be an internet-connected furnace system that may calculate the amount of energy required to maintain a temperature in an environment for a 24 hour period, and may purchase only an amount of energy required to maintain the temperature of the environment. Thus, the plurality of energy consumption devices 110a, 110b . . . 110n may communicate with the energy metering device 120 to request that the energy metering device 120 purchase energy from the energy provider system 112 on an as-needed basis.

Embodiments of the plurality of energy consumption devices 110a, 110b . . . 110n may include hardware and software components for analyzing an energy need, such as a microcontroller, camera, sensor(s), network interface controller, and an I/O interface. Software components of the plurality of energy consumption devices 110a, 110b . . . 110n may be located in a memory system of the plurality of energy consumption devices 110a, 110b . . . 110n. Embodiments of the plurality of energy consumption devices 110a, 110b . . . 110n may include a microcontroller for implementing the tasks associated with the plurality of energy consumption devices 110a, 110b . . . 110n. Embodiments of the plurality of energy consumption devices 110a, 110b . . . 110n may include a network interface controller. Embodiments of the network interface controller may be a hardware component of the plurality of energy consumption devices 110a, 110b . . . 110n that may connect the plurality of energy consumption devices 110a, 110b . . . 110n to communication network 107. The network interface controller may transmit and receive data, including the transmission of energy data acquired, collected, captured, or otherwise obtained by the plurality of energy consumption devices 110a, 110b . . . 110n. In some embodiments, the energy data may be stored in a storage device of the memory system of the plurality of energy consumption devices 110a, 110b . . . 110n. The network interface controller may access the storage device, and transmit the energy data and requests to purchase energy over the network 107 to the energy metering device 120. Additionally, embodiments of plurality of energy consumption devices 110a, 110b . . . 110n may include an I/O interface. An I/O interface may refer to any communication process performed between the plurality of energy consumption devices 110a, 110b . . . 110n and the environment outside of the plurality of energy consumption devices 110a, 110b . . . 110n. Input to the plurality of energy consumption devices 110a, 110b . . . 110n may refer to the signals or instructions sent to the plurality of energy consumption devices 110a, 110b . . . 110n, for example data or meta data relating to energy needs of the plurality of energy consumption devices 110a, 110b . . . 110n, while output may refer to the signals sent out from the plurality of energy consumption devices 110a, 110b . . . 110n.

Referring back to FIG. 3, embodiments of the energy metering device 120 may be a computing system that includes a provider interface module 131, an allocation module 132, a request module 133, and an energy purchase module 134. A “module” may refer to a hardware based module, software based module or a module may be a combination of hardware and software. Embodiments of hardware based modules may include self-contained components such as chipsets, specialized circuitry and one or more memory devices, while a software-based module may be part of a program code or linked to the program code containing specific programmed instructions, which may be loaded in the memory device of the energy metering device 120. A module (whether hardware, software, or a combination thereof) may be designed to implement or execute one or more particular functions or routines.

Embodiments of the provider interface module 131 may include one or more components of hardware and/or software program code for interfacing with the energy provider system 112 to purchase and sell energy units, in accordance with a capped total amount of energy allowed for the network 201. The capped total amount of energy allowed to consume by the network 201 may be provided by the energy provider 6, a local, state, or federal government body or agency, company headquarters, or other governing or managing entity. In other embodiments, the capped total amount of energy for the network 201 may be requested by the user/owner of the network 201 in attempt to maintain a certain budget over a period of time, or as a way to reduce a load on the electrical grid 1000. In other embodiments, the provider interface module 131 of the energy metering device 120 may analyze and/or predict future needs of the network 201 (e.g. changing number of total devices, changing climate, seasons, weather, etc.) and request a capped amount of energy for the network 201. The requests sent by the energy metering device 120 may be hourly requests, daily requests, weekly requests, monthly requests, bi monthly requests, yearly requests, or on-demand, real-time requests. For instance, the energy metering device 120 may access a website that includes weather information, and may request a total amount of capped energy for the next day or next week based on a weather prediction model. The request(s) may be approved or denied by the energy provider system 112. In response to the request from the energy metering device 120, or as a function of a calculated allotment for the network performed by the energy provider 6 or other authority, the provider interface module 131 may obtain or otherwise receive a total capped amount of energy that can be consumed by the network 201, for a given period of time.

The total amount of energy that can be consumed by the network 201 for a given period of time may be received by the energy metering device 120 in a form of a cryptocurrency, wherein the cryptocurrency may be used to purchase a unit of energy. A cryptocurrency may be a digital currency in which encryption techniques may be used to regulate a generation of units of currency, as well as verify a transfer of the units of digital currency. The utilization of the cryptocurrency may be operated independent of a central database system, such as a central bank, a central management system, or central authority operated by the energy provider 6. The cryptocurrency may be a bitcoin, an altcoin, or a derivative of a bitcoin, or any digital currency. Each unit cryptocurrency may represent a unit or a portion of a unit of energy. For example, if 1 cryptocurrency unit is set to be equivalent to 1 kWh, the provider interface module 131 may receive a capped total amount of cryptocurrency of 800 for a month to spend on purchasing 800 kWh of electricity. Various conversion rates may be used between a unit of cryptocurrency and a unit of energy, as well as the total capped amount of cryptocurrency. The transfer of the capped amount of cryptocurrency may be between the energy provider system 112 associated with the energy provider 6 (or energy producer 5 if the energy provider is the same as the manufacturer) and the energy metering device 120.

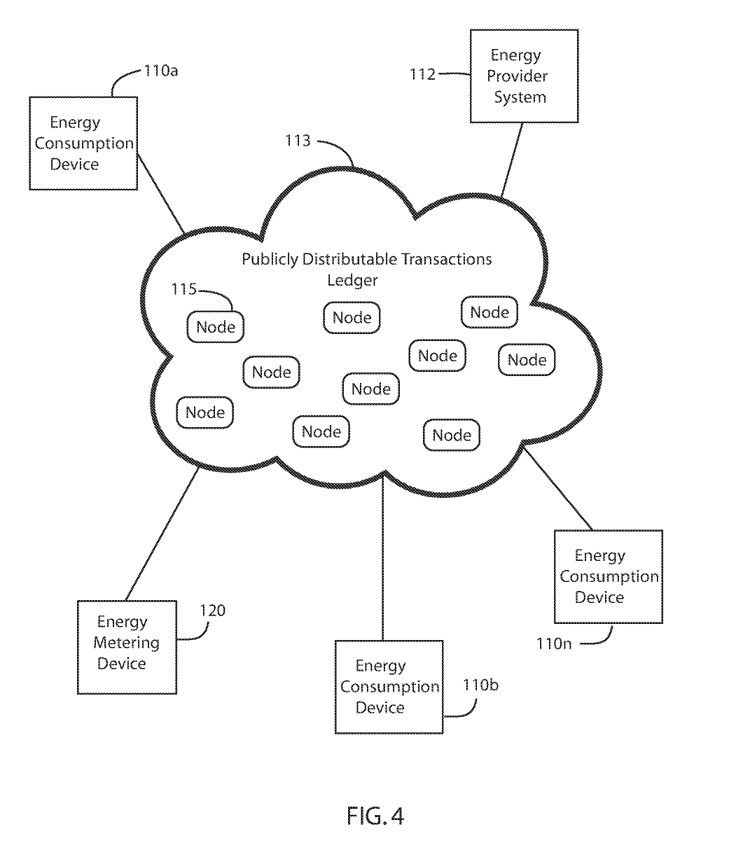

The transfer of the cryptocurrency to the energy metering device 120 may be recorded on a publicly distributable transactions ledger 113, by the provider interface module 131 when the cryptocurrency is received by the energy metering device 120. The recordation of the transfer is immutable and almost impossible to fraudulently change the details of the transfer saved on the ledger 113 due to the nature of the decentralized ledger, otherwise referred to as the blockchain. FIG. 4 depicts an embodiment of a publicly distributable transactions ledger 113, in accordance with embodiments of the present invention. Embodiments of ledger 113 may be a distributed peer-to-peer network, including a plurality of nodes 115. The ledger 113 may represent a computing environment for operating a decentralized framework that can maintain a distributed data structure. In other words, ledger 113 may be a secure distributed transaction ledger or a blockchain that may support cryptocurrency. Each node 115 may maintain an individual public ledger (i.e. maintained publicly) according to set procedures that employ cryptographic methods and a proof-of-work concept. In view of the public nature of the ledger and the proof-of-work concept, the nodes 115 collectively create a decentralized, trusted network. Further, embodiments of the publicly decentralized trusted ledger 113 may be accessible by the energy metering device 120, the plurality of energy consuming devices 110a, 110b . . . 110n, and the energy provider system 112, for verifying a transaction or completing a transaction using the cryptocurrency.

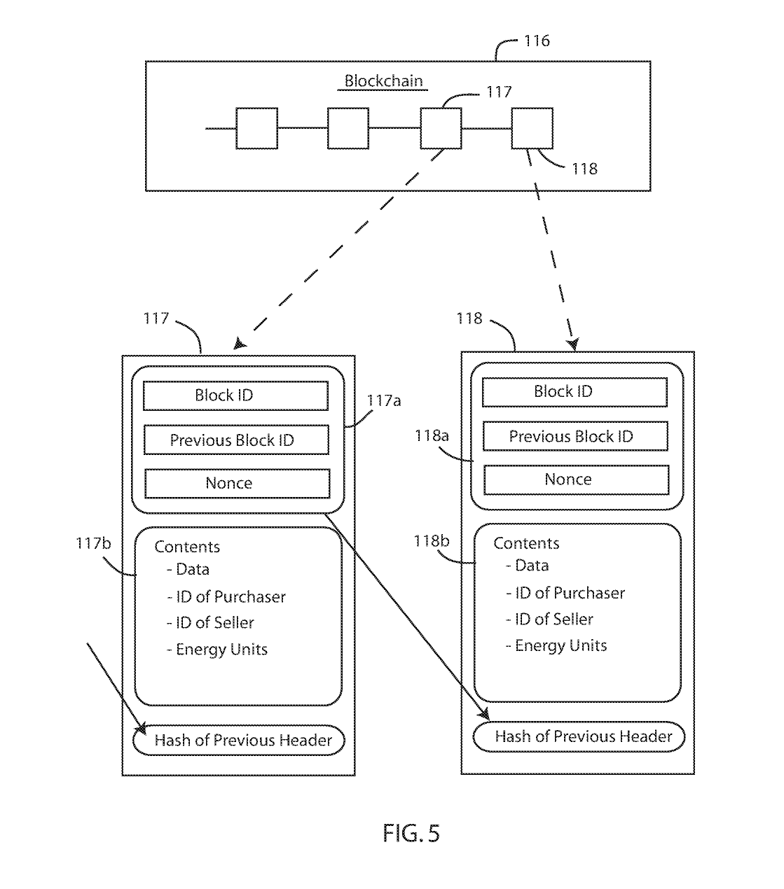

FIG. 5 depicts a blockchain 116 and two exemplary blocks 117, 118 of the blockchain 116, in accordance with embodiments of the present invention. Embodiments of the blockchain 116 may represent the publicly distributable transactions ledger 113, and may include a plurality of blocks. Each block, such as block 117 and block 118 may include data regarding recent transactions and/or contents relating to buying/selling energy units, linking data that links one block 118 to a previous block 117 in the blockchain, proof-of-work data that ensures that the state of the blockchain 116 is valid, and is endorsed/verified by a majority of the record keeping system. The confirmed transactions of the blockchain are done using cryptography to ensure that the integrity and the chronological order of the blockchain are enforced and can be independently verified by each node 115 of the blockchain 116. New transactions may be added to the blockchain 116 using a distributed consensus system that confirms pending transactions using a mining process, which means that each transaction can easily be verified for accuracy, but very difficult or impossible to modify. Moreover, embodiments of a block 117 of the blockchain 116 may include a header 117a and a content 117b. Embodiments of the header 117a may include a block ID, a previous block ID, and a nonce. The nonce may represent a proof-of-work. The header 117a may be used to link block 117 to other blocks of the blockchain. Embodiments of the block contents 117b may include transaction information relating to a transaction for a unit of energy based on a unit of cryptocurrency. Likewise, block 118 may include a header 118a and contents 118b. Block 118 includes a hash of the previous block's header (i.e. 117a), thereby linking the blocks 117, 118 to the blockchain.

The transaction information cannot be modified without at least one of the nodes 115 noticing; thus, the blockchain 116 can be trusted to verify transactions occurring between the energy metering device 120, the energy consumption devices 110a, 110b . . . 110n, and the energy provider system 112. For instance, the energy metering device 120 may not be allowed to spend more than the capped total cryptocurrency received from the energy provider system 112 because the blockchain 116 will not allow the energy metering device 120 to “double spend.” In other words, the blockchain 116 can verify that the energy metering device 120 has a remaining amount of cryptocurrency to spend on energy.

Referring back to FIG. 3, embodiments of the energy metering device 120 may also include an allocation module 132. Embodiments of the allocation module 132 may include one or more components of hardware and/or software program code for allocating an amount of the total capped cryptocurrency of the network 201 for each energy consumption device 110a, 110b . . . 110n on the network 201. In response to receiving the capped total of cryptocurrency from the energy provider system 112, the allocation module 132 may detect the energy consumption devices 110a, 110b . . . 110n on the network 201. The total cryptocurrency allotted for number of the energy consumption devices 110a, 110b . . . 110n on the network 201 may depend on various factors, such as average use, requested amount, importance, user-specified rankings, time of year, season, climate, geographical location of the network 201, and the like, or combinations thereof. In an exemplary embodiment, the allocation module 132 may calculate a current energy need of a consumption device based on a historical analysis of energy use, or may calculate an average use for each energy consumption device based on historical analysis. In other embodiments, the allocation module 132 may analyze requests and/or data and information transmitted to the energy metering device 120 from the energy consumption devices 110a, 110b . . . 110n. By analyzing the information sent by the energy consumption devices 110a, 110b . . . 110n, the allocation module 132 may allocate an amount of cryptocurrency that the energy consumption devices 110a, 110b . . . 110n may spend on energy units. As an example, if the total capped cryptocurrency for the network 201 is capped at 800 kWh, wherein 1 cryptocurrency unit is equivalent to 1 kWh and the network includes 20 energy consumption devices 110a, 110b . . . 110n, then the allocation module 132 may allocate, apportion, reserve, set aside, transfer, or otherwise account for 40 cryptocurrency units for each device. Once the allocation module 132 has allocated a certain number of cryptocurrency available to each energy consumption devices 110a, 110b . . . 110n, the data/information may be recorded in the publicly distributable transaction ledger 113 (i.e. blockchain 116). Due to the immutable characteristics of the blockchain 116, each energy consumption devices 110a, 110b . . . 110n may only be able to spend the allotted cryptocurrency.

Embodiments of the computing system 120 may further include a request module 133. Embodiments of the request module 133 may refer to configurations of hardware, software program code, or combinations of hardware and software programs for services request from the energy consumption devices 110a, 110b . . . 110n to purchase a unit of energy from the electrical grid 1000. For instance, an energy consumption device 110a, 110b . . . 110n may communicate with the request module 133 of the energy metering device 120 to request that the energy metering device 120 purchase a unit of energy based on a current need of the energy consumption device. In response to receiving the request to purchase the unit of energy, the request module 133 may access the public distributable transaction ledger to verify that the energy consumption device indeed has a remaining amount of cryptocurrency to spend on energy. Additionally, the request module 133 of the energy metering device 120 may also access the ledger 113 to verify that the total capped amount of cryptocurrency has not been exceed for the network. In other embodiments, the energy metering device 120 may attempt the transaction without accessing the ledger 113, and if the energy consumption device 110a has no remaining cryptocurrency, the blockchain 116 will not provide a consensus among the nodes 115 of the blockchain 116, and the transaction will be denied. However, accessing the ledger 113 with the energy metering device 113 prior to attempting a transaction may allow the request module 133 of the energy metering device 120 to notify the energy consumption device 110a of insufficient cryptocurrency, and recommend seeking cryptocurrency from another energy consumption device 110b on the same network 201. For example, if the energy consumption device 110a has no remaining cryptocurrency, an additional energy consumption device 110b on the single network 201 may transfer cryptocurrency to the energy consumption device 110a, and the transfer is recorded in the publicly distributed transaction ledger 113. In some embodiments, the request module 132 of the energy metering device 120 may control and/or decide whether other energy consumption devices 110b may or should transfer cryptocurrency to other devices. Prior to a transfer between devices 110a, 110b, the request module 133 may access the publicly distributed transaction ledger 113 to verify that the additional energy consumption device 110b has cryptocurrency to sell to the energy consumption device.

Alternatively, the energy consumption device 110a may interface with the energy provider system 112 directly to purchase an energy unit using a cryptocurrency unit of the device 110a. If the energy consumption device 110a attempts to purchase a unit of energy from the energy provider system 112 without remaining cryptocurrency, the blockchain 116 will not provide a consensus among the nodes 115 of the blockchain 116, and the transaction will be denied.

With continued reference to FIG. 1, embodiments of the energy metering device 120 may include a purchase module 134. Embodiments of the purchase module 134 may include one or more components of hardware and/or software program code for purchasing the energy unit with cryptocurrency from the energy provider system 112. The purchase transaction may be recorded on the ledger 113, and a consensus of the nodes 115 may be received to confirm that the energy metering device 120 has not exceeded the total cap of energy to be consumed for the network 201 associated with the energy metering device 120. The purchase module 134 may interface or otherwise communication with a computing system of the energy provider system 112 to purchase or otherwise obtain an energy unit (e.g. kWh) from the energy provider 6 to delivered to the network 201. The energy metering device 120 may instruct or direct the energy to the requesting energy consumption device 110a.

Furthermore, if a network 201 has remaining or excess cryptocurrency after a given period of time, the energy metering device 120 may sell the excess or remaining cryptocurrency back to the energy provider system 112 or to other networks 201. Alternatively, the energy metering device 120 may toll the excess cryptocurrency for usage in the next cycle. In other embodiments, the energy metering device 120 may sell the cryptocurrency to other networks on the grid 1000 in exchange for digital currency representing something other than a unit of energy, such as bitcoin or other monetary value/currency. Further, each energy consumption device 110a, 110b, 110n may sell or transfer remaining or excess cryptocurrency to other devices on the network 201.

In an exemplary embodiment, a network 201 that has remaining or excess cryptocurrency after a given period of time, may, via the energy metering device 120, sell or otherwise transfer (e.g. without a fee) excess or remaining cryptocurrency to other networks 201. For instance, if a plurality of networks 201 are store locations of a single company, each store location may share or otherwise allocate energy or cryptocurrency to other store locations as needed. Stores that are located in different time zones may have different high energy outputs at different times of the day. Thus, a store requesting additional energy units or cryptocurrency at a given busy time for that store may receive energy units or cryptocurrency from another store that is operating in a low-power mode at a less busy time, such as at night, or when the store is closed. Further, the store locations may be combined to define one larger network 201, such as a co-op, wherein energy units may be shared, allocated, or purchased from store to store. The sharing of cryptocurrency may be at a network-to-network level, or may be on a device-to-device level from each store, and may be characterized by type of energy consumption device. For example, a heating and cooling system of a first store (e.g. energy consumption device 110 associated with a first energy metering apparatus) may communicate with a heating and cooling system of a second store (e.g. energy consumption device 110 associated with a second energy metering apparatus 120). If the heating and cooling system of the first store is using much less energy, then the heating and cooling system of the first store is storing or saving cryptocurrency, which can be allocated to the heating and cooling system of the second store, if the heating and cooling system of the second store needs additional cryptocurrency to purchase energy units.

Embodiments of the energy metering device 120 may be a hardware unit installed on or around the network 201, wherein the energy metering device 120 includes a computing system having the modules 131-134, and may be equipped with a memory device 142 which may store various information and data regarding the energy uses and needs of the energy consumption devices 110a, 110b . . . 110n, and a processor 141 for implementing the tasks associated with the electrical grid management system 100. In other embodiments, the energy metering device 120 may be a metering device for other consumed resources, information, items, and the like that are capable of regulation that are delivered to a network 201, such as water (gallons, liters, etc.), natural gas (Ccf, Mcf, BTU, therms, etc), cell data (GB, MB, KB), and the like. Instead of processing the buying and selling of electricity, the metering device could monitor the buying and selling of water, natural gas, cell data, and the like, wherein each connected device is interconnected as described above, and may use the cryptocurrency to purchase units or quantums of water, natural gas, cell data, and the like. Further, as opposed to managing a demand on the electrical grid, the metering device associated with network 201 may reduce an amount of water consumption in regions where water is scarce, or may reduce a load on one or more cell towers servicing the network 201, which may likewise have an aggregate effect.

Furthermore, the purchase module 134 may perform an audit function on the network 201, or for each energy consumption device within the network 201. The audit functionality of the buying and selling of cryptocurrency representing units of energy may allow a governing unit or management team of one or more networks to perform checks and create predictive reports for determining a total capped amount of energy that may be allotted or otherwise assigned to a particular network. The audit functionality of the purchase module 134 may also help provide data for analyzing an efficiency of the energy consumption device, which may be helpful in determining which energy consumption devices may be swapped out or eliminated from the network 201 to increase an efficiency of the network 201.

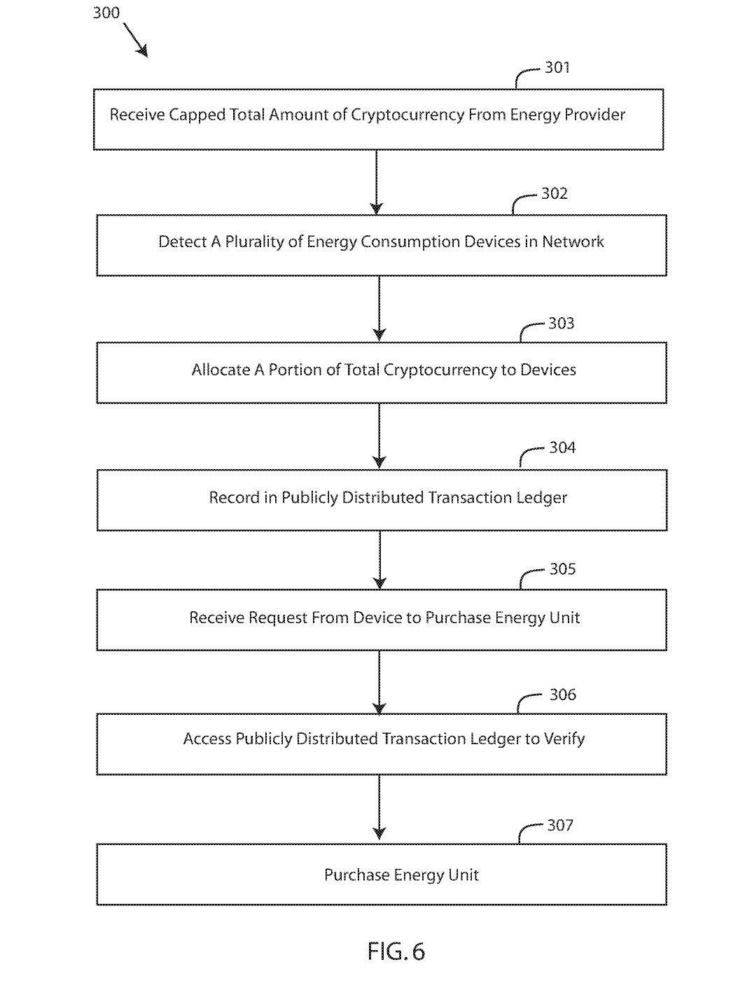

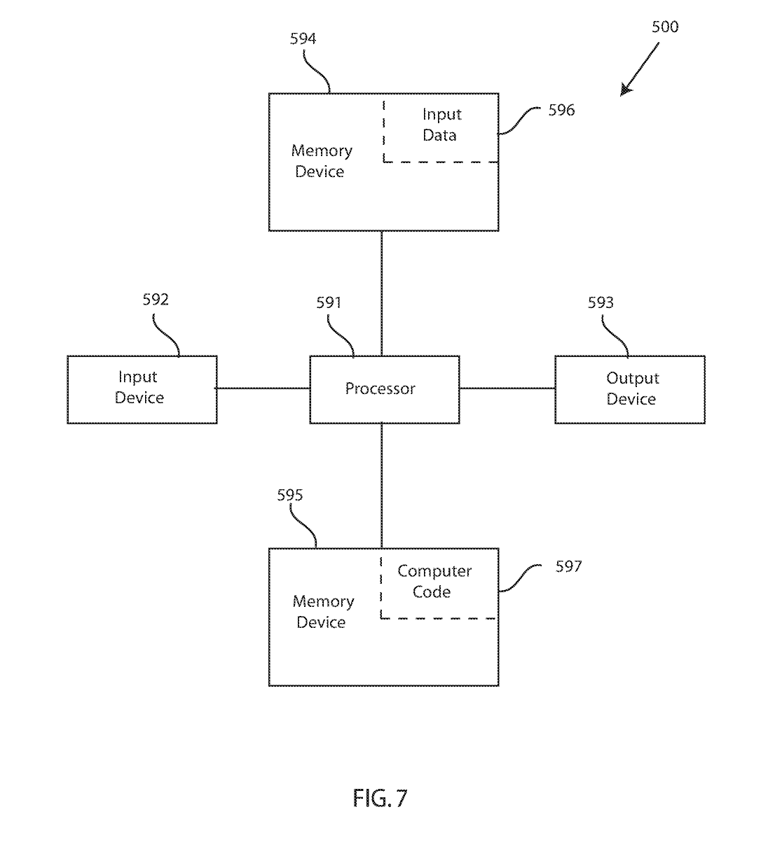

Referring now to FIG. 6, which depicts a flow chart of a method 300 for managing a demand of an electrical grid, in accordance with embodiments of the present invention. One embodiment of a method 300 or algorithm that may be implemented for managing a demand of an electrical grid in accordance with the electrical grid management system 100 described in FIG. 3 using one or more computer systems as defined generically in FIG. 7 below, and more specifically by the specific embodiments of FIGS. 3-5.

Embodiments of the method 300 for managing a demand of an electrical grid may begin at step 301 wherein a capped total amount of cryptocurrency is received from the energy provider system 112. The capped amount may be a total amount of cryptocurrency that can be used to purchase a set, limited amount of energy from the grid 1000 for a network for a given period of time. Step 302 detects the plurality of energy consumption devices 110a, 110b . . . 110n present or connected to the network 201. Step 303 allocates a portion of the total cryptocurrency to the plurality of energy consumption devices 110a, 110b . . . 110n. For instance, each energy consumption device 110a, 110b . . . 110n may be allowed to spend a capped amount of cryptocurrency on energy for a given time period. This may reduce an overall impact or load on the electrical grid 1000 because each energy consuming device may be forced to efficiently use each quantum of energy. Step 304 records the cryptocurrency allotted to each device and the network 201 as a whole on the publicly distributable transaction ledger 113 so that each transaction of cryptocurrency can be verified by a decentralized database, which ensures that the cap limits are not exceeded. Step 305 receives a request from an energy consumption device 110 to purchase an energy unit using cryptocurrency. Step 306 accesses the ledger 113 to verify that the energy consumption device 110a has a remaining amount of cryptocurrency to spend on energy, as well as verifying that a maximum amount for the entire network 201 has not been exceeded. If the ledger 113 confirms that the transaction is valid, then step 307 purchases the energy to be delivered to the energy consumption device 307.

FIG. 7 illustrates a block diagram of a computer system for the electrical grid management system of FIG. 3, capable of implementing methods for managing a demand on an electrical grid of FIG. 5, in accordance with embodiments of the present invention. The computer system 500 may generally comprise a processor 591, an input device 592 coupled to the processor 591, an output device 593 coupled to the processor 591, and memory devices 594 and 595 each coupled to the processor 591. The input device 592, output device 593 and memory devices 594, 595 may each be coupled to the processor 591 via a bus. Processor 591 may perform computations and control the functions of computer 500, including executing instructions included in the computer code 597 for the tools and programs capable of implementing a method for managing a demand on an electrical grid, in the manner prescribed by the embodiments of FIG. 6 using the electrical grid management system of FIGS. 3-5, wherein the instructions of the computer code 597 may be executed by processor 591 via memory device 595. The computer code 597 may include software or program instructions that may implement one or more algorithms for implementing the methods for managing a demand on an electrical grid, as described in detail above. The processor 591 executes the computer code 597. Processor 591 may include a single processing unit, or may be distributed across one or more processing units in one or more locations (e.g., on a client and server).

The memory device 594 may include input data 596. The input data 596 includes any inputs required by the computer code 597. The output device 593 displays output from the computer code 597. Either or both memory devices 594 and 595 may be used as a computer usable storage medium (or program storage device) having a computer readable program embodied therein and/or having other data stored therein, wherein the computer readable program comprises the computer code 597. Generally, a computer program product (or, alternatively, an article of manufacture) of the computer system 500 may comprise said computer usable storage medium (or said program storage device).

Memory devices 594, 595 include any known computer readable storage medium, including those described in detail below. In one embodiment, cache memory elements of memory devices 594, 595 may provide temporary storage of at least some program code (e.g., computer code 597) in order to reduce the number of times code must be retrieved from bulk storage while instructions of the computer code 597 are executed. Moreover, similar to processor 591, memory devices 594, 595 may reside at a single physical location, including one or more types of data storage, or be distributed across a plurality of physical systems in various forms. Further, memory devices 594, 595 can include data distributed across, for example, a local area network (LAN) or a wide area network (WAN). Further, memory devices 594, 595 may include an operating system (not shown) and may include other systems not shown in FIG. 7.

In some embodiments, the computer system 500 may further be coupled to an Input/output (I/O) interface and a computer data storage unit. An I/O interface may include any system for exchanging information to or from an input device 592 or output device 593. The input device 592 may be, inter alia, a keyboard, a mouse, etc. or in some embodiments the energy consumption devices 110a, 110b . . . 110n. The output device 593 may be, inter alia, a printer, a plotter, a display device (such as a computer screen), a magnetic tape, a removable hard disk, a floppy disk, etc. The memory devices 594 and 595 may be, inter alia, a hard disk, a floppy disk, a magnetic tape, an optical storage such as a compact disc (CD) or a digital video disc (DVD), a dynamic random access memory (DRAM), a read-only memory (ROM), etc. The bus may provide a communication link between each of the components in computer 500, and may include any type of transmission link, including electrical, optical, wireless, etc.

An I/O interface may allow computer system 500 to store information (e.g., data or program instructions such as program code 597) on and retrieve the information from computer data storage unit (not shown). Computer data storage unit includes a known computer-readable storage medium, which is described below. In one embodiment, computer data storage unit may be a non-volatile data storage device, such as a magnetic disk drive (i.e., hard disk drive) or an optical disc drive (e.g., a CD-ROM drive which receives a CD-ROM disk). In other embodiments, the data storage unit may include a knowledge base or data repository 125 as shown in FIG. 3.

As will be appreciated by one skilled in the art, in a first embodiment, the present invention may be a method; in a second embodiment, the present invention may be a system; and in a third embodiment, the present invention may be a computer program product. Any of the components of the embodiments of the present invention can be deployed, managed, serviced, etc. by a service provider that offers to deploy or integrate computing infrastructure with respect to electrical grid management systems and methods. Thus, an embodiment of the present invention discloses a process for supporting computer infrastructure, where the process includes providing at least one support service for at least one of integrating, hosting, maintaining and deploying computer-readable code (e.g., program code 597) in a computer system (e.g., computer 500) including one or more processor(s) 591, wherein the processor(s) carry out instructions contained in the computer code 597 causing the computer system to manage or regulate a demand on the electrical grid. Another embodiment discloses a process for supporting computer infrastructure, where the process includes integrating computer-readable program code into a computer system including a processor.

The step of integrating includes storing the program code in a computer-readable storage device of the computer system through use of the processor. The program code, upon being executed by the processor, implements a method for managing a demand on an electrical grid. Thus, the present invention discloses a process for supporting, deploying and/or integrating computer infrastructure, integrating, hosting, maintaining, and deploying computer-readable code into the computer system 500, wherein the code in combination with the computer system 500 is capable of performing a method for managing a demand on an electrical grid.

A computer program product of the present invention comprises one or more computer readable hardware storage devices having computer readable program code stored therein, said program code containing instructions executable by one or more processors of a computer system to implement the methods of the present invention.

A computer system of the present invention comprises one or more processors, one or more memories, and one or more computer readable hardware storage devices, said one or more hardware storage devices containing program code executable by the one or more processors via the one or more memories to implement the methods of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method for managing a demand on an electrical grid, comprising:
receiving, by an energy metering device, a capped total amount of cryptocurrency available to purchase units of energy from an energy provider over a period of time for a single network connected to the electrical grid, the capped total amount of cryptocurrency being recorded in a publicly distributed transaction ledger;
detecting, by the energy metering device, a plurality of energy consumption devices associated with the single network;
allocating, by the energy metering device, a portion of the cryptocurrency of the capped total amount of cryptocurrency to each energy consumption device, wherein the portion of the cryptocurrency allocated to each energy consumption device is recorded in the publicly distributed transaction ledger;
receiving, by the energy metering device, a request from an energy consumption device of the plurality of energy consumption devices that the energy metering device purchase an energy unit from the energy provider, using the portion of cryptocurrency allocated to the first energy consumption device, the request based on a current energy need of the first energy consumption device;
accessing, by the energy metering device, the publically distributed transaction ledger in response to receiving the request from the first energy consumption to verify that the first energy consumption device has a remaining amount of cryptocurrency; and
purchasing, by the energy metering device, a unit of energy from the energy provider to be delivered to the first energy device after verifying that the first energy consumption device has sufficient cryptocurrency to spend on energy.

2. The method of claim 1, wherein, in response to a request to purchase the energy unit by the energy metering device, the energy provider accesses the publicly distributed database to verify that the energy metering device has not exceeded the capped total amount of cryptocurrency available to purchase energy.

3. The method of claim 1, wherein the period of time is at least one of a day, a month, a three month period, a six month period, and a year.

4. The method of claim 1, wherein the plurality of energy consumption devices are interconnected over a communication network, the energy metering device is connected to the plurality of energy consumption devices over the communication network, and the energy metering device is connected to the energy provider over the communication network.

5. The method of claim 1, wherein, if the energy consumption device has no remaining cryptocurrency, an additional energy consumption device on the single network transfers cryptocurrency to the energy consumption device, and the transfer is recorded in the publicly distributed transaction ledger.

6. The method of claim 4, wherein the energy metering device accesses the publicly distributed transaction ledger to verify that the additional energy consumption device has cryptocurrency to sell to the energy consumption device.

7. The method of claim 1, wherein accessing further includes verifying that the single the capped total amount of cryptocurrency is not exceeded.

8. The method of claim 1, wherein the single network is at least one of: a residence, a commercial building, an office, and a neighborhood comprising a plurality of residences.

9. The method of claim 1, wherein the plurality of energy consumption devices includes an appliance, a light source, an entertainment console, a computing device, a heating system, a cooling system, and a water heating system, that connects to the internet.

10. The method of claim 1, further comprising: calculating, by the energy metering device, an average energy need of each energy consumption device of the plurality of energy consumption devices over the period of time, wherein the allocation is based on the average need of each energy consumption device.

11. A system for managing a demand on an electrical grid, comprising:
an energy provider, the energy provider configured to deliver a limited amount of energy to a single network, the energy provider determining a capped total amount of cryptocurrency available for purchase by the single network; and
an energy metering device, the first energy metering device being associated with the single network, and communicatively coupled to the energy provider over a communication network;
wherein the first energy metering device manages the demand on the electrical grid by:
receiving, by the energy metering device, the capped total amount of cryptocurrency available to purchase units of energy from the energy provider over a period of time for the single network connected to the electrical grid, the capped total amount of cryptocurrency being recorded in a publicly distributed transaction ledger;
detecting, by the energy metering device, a plurality of energy consumption devices associated with the single network;
allocating, by the energy metering device, a portion of the cryptocurrency of the capped total amount of cryptocurrency to each energy consumption device, wherein the portion of the cryptocurrency allocated to each energy consumption device is recorded in the publicly distributed transaction ledger;
receiving, by the energy metering device, a request from an energy consumption device of the plurality of energy consumption devices that the energy metering device purchase an energy unit from the energy provider, using the portion of cryptocurrency allocated to the first energy consumption device, the request based on a current energy need of the first energy consumption device;
accessing, by the energy metering device, the publically distributed transaction ledger in response to receiving the request from the first energy consumption to verify that the first energy consumption device has a remaining amount of cryptocurrency; and
purchasing, by the energy metering device, a unit of energy from the energy provider to be delivered to the first energy device after verifying that the first energy consumption device has sufficient cryptocurrency to spend on energy.

12. The system of claim 11, further comprising: an additional energy metering device associated with an additional network connected to the electrical grid.

13. The system of claim 11, wherein, in response to a request to purchase the energy unit by the energy metering device, the energy provider accesses the publicly distributed database to verify that the energy metering device has not exceeded the capped total amount of cryptocurrency available to purchase energy.

14. The system of claim 11, wherein the period of time is at least one of: a day, a month, a three month period, a six month period, and a year.

15. The system of claim 11, wherein the plurality of energy consumption devices are interconnected over the communication network.

16. The system of claim 11, wherein, if the energy consumption device has no remaining cryptocurrency, an additional energy consumption device on the single network transfers cryptocurrency to the energy consumption device, and the transfer is recorded in the publicly distributed transaction ledger.

17. The system of claim 16, wherein the energy metering device accesses the publicly distributed transaction ledger to verify that the additional energy consumption device has cryptocurrency to sell to the energy consumption device.

18. The system of claim 11, wherein accessing further includes verifying that the single the capped total amount of cryptocurrency is not exceeded.

19. The system of claim 11, wherein the single network is at least one of: a residence, a commercial building, an office, and a neighborhood comprising a plurality of residences.

20. A computer system, comprising:
a processor;
a memory device coupled to the processor; and
a computer readable storage device coupled to the processor, wherein the storage device contains program code executable by the processor via the memory device to implement a method for managing a demand of an electrical grid, the method comprising:
receiving, by an energy metering device, a capped total amount of cryptocurrency available to purchase units of energy from an energy provider over a period of time for a single network connected to the electrical grid, the capped total amount of cryptocurrency being recorded in a publicly distributed transaction ledger;
detecting, by the energy metering device, a plurality of energy consumption devices associated with the single network;
allocating, by the energy metering device, a portion of the cryptocurrency of the capped total amount of cryptocurrency to each energy consumption device, wherein the portion of the cryptocurrency allocated to each energy consumption device is recorded in the publicly distributed transaction ledger;
receiving, by the energy metering device, a request from an energy consumption device of the plurality of energy consumption devices that the energy metering device purchase an energy unit from the energy provider, using the portion of cryptocurrency allocated to the first energy consumption device, the request based on a current energy need of the first energy consumption device;
accessing, by the energy metering device, the publically distributed transaction ledger in response to receiving the request from the first energy consumption to verify that the first energy consumption device has a remaining amount of cryptocurrency; and
purchasing, by the energy metering device, a unit of energy from the energy provider to be delivered to the first energy device after verifying that the first energy consumption device has sufficient cryptocurrency to spend on energy.
